(19) United States
(12) Patent Application Publication
(10) Pub. No.: US 2019/0050117 A1
(43) Pub. Date: Feb. 14, 2019

(54) USER INTERFACE FOR MANIPULATING A DATA SET

(71) Applicant: NUMERABLE SOFTWARE LIMITED, Bristol (GB)

(72) Inventor: Martin Coulthard, Bristol (GB)

(21) Appl. No.: 16/057,073

(22) Filed: Aug. 7, 2018

(30) Foreign Application Priority Data
Aug. 9, 2017 (GB) 1712773.9

(51) Int. Cl. G06F 3/0482; G06F 3/0488; G06F 3/0484

(52) U.S. Cl. CPC G06F 3/0482; G06F 3/04845; G06F 3/04886

(57) ABSTRACT

A user interface for manipulating a data set comprising at least two data points, wherein each data point has at least three variables, the user interface comprising a data display region, a first set of selectable user interface items arranged in a row and representing values of a first variable of the data set, and a second set of selectable user interface items arranged in a column and representing values of a second variable of the data set, wherein the user selectable user interface items of the first and second sets can be used to manipulate representations of the data set presented in the data display region. The user interface is compact, intuitive and straightforward to learn and use, and requires minimal user interactions to configure a plot. Using the user interface, complex data sets having three or more variables can be visualised quickly and easily.

This application claims the benefit of and priority to United Kingdom Patent Application No. 1712773.9, filed on Aug. 9, 2018, the contents of which are incorporated herein by reference.

### TECHNICAL FIELD

The present invention relates to a user interface for manipulating a data set.

### BACKGROUND OF THE INVENTION

Plots and graphs are widely used to represent data. They show data as graphical elements whose size, position, colour or other characteristics relate to the values of and relationships between the data variables. They help people understand patterns and information in the data set, such as trends, correlations, grouping and outliers, and can do so more effectively than lists or tables of numbers.

A wide variety of types of computer software is available to generate plots. These include standard products like spreadsheets (e.g. Microsoft Excel), business intelligence software (e.g. Microsoft Power BI, Tableau, Qlik), technical software (e.g. MATLAB) and general-purpose data visualisation software (e.g. Plot.ly). Furthermore, many custom-coded software programs have been developed for specific purposes.

The functionality of such software may include features for configuring a plot, and for exploring, presenting or publishing it in static or sometimes interactive form.

Configuration of a plot involves the user using lists, menus, buttons or other user interface elements that are not part of the main plot/data display region. A series of user actions is typically required. These can include selection of the data to be plotted, choice of a plot type, allocation of variables to axes, setting of appearance characteristics of plot elements, configuration of axes and title labelling.

Plots can be either static or interactive. In a static plot, the representation of the data set is fixed and cannot readily be changed by a user.

Interactive plots, on the other hand, allow the user to change the plot to show desired aspects of the data set. User interactions in an interactive plot include browsing, drill up and down, filtering, zooming and sorting. Interactivity allows the user to explore a data set in a dynamic way and can help improve understanding of it.

However, existing interactive plots typically require the user to interact with user interface elements that are separated from the main data display region (which consists of the axes, their labels and headers, and the plot elements themselves). This reduces the space available for the data display region, and means that the user's attention is directed away from the data display region. An example of such separate user interface elements is a chart legend that identifies a series of plot elements by their colour, and may allow the user to select which series of data points they wish to view on the plot. Another example is a series of icons, each representing a different plot type that a user can select in order to change the plot to that new type.

Existing plotting software programs suffer from one or more of the following drawbacks:
they are complex and hard to learn and use;
they have a limited degree of interactivity;
different tables, plots and views that are separate from each other;
multiple user actions are required to configure a plot;
they include user interface elements that are separated from the main data display region, so for a given screen the size of the data display region is reduced and the user's attention is drawn away from the plot;
they are not well suited to use on mobile devices with small screens and touchscreen interfaces.

These difficulties are compounded when it is desirable to plot and interact with a data set that has three or more variables and it is necessary to select the combination of variables to be plotted.

The current invention is a compact, integrated, intuitive user interface that overcomes these drawbacks of existing plotting software, and requires little or no configuration.

### SUMMARY OF INVENTION

According to a first aspect of the present invention there is provided a user interface for manipulating a data set comprising at least two data points, wherein each data point has at least three variables, the user interface comprising: a data display region; a first set of user selectable user interface elements arranged in a row, wherein the first set of user selectable user interface elements represents values of a first variable of the data set; a second set of user selectable user interface elements arranged in a column, wherein the second set of user selectable user interface elements represents values of a second variable of the data set, wherein the user interface is arranged such that, in response to a user selection of a first one of the first set of user selectable user interface elements, a first graphical representation of the values of a third variable, for data points having the value of the first variable represented by the selected user interface element, is displayed in the data display region, plotted against the values of the second variable represented by the second set of user selectable interface elements, and wherein the user interface is arranged such that, in response to a user selection of a first one of the second set of user selectable user interface elements, a second graphical representation of the values of the third variable, for data points having the value of the second variable represented by the selected user interface element, is displayed in the data display region, plotted against the values of the first variable represented by the first set of user selectable interface elements.

An effect of this compact arrangement of the user interface, and the lack of user interface elements separate from the data display region, is that substantially all of a screen can be used for the data display region, making the data display region as large as possible. This is particularly important on computing devices such as smartphones and tablets that have relatively small screens, as it allows more data to be displayed at a size the is clearly visible, and interacted with using user interface elements of a practical size.

When viewing and interacting with the interface, the user's attention to the data display region is not broken by the need to shift visual focus from the data display region to other user interface elements separated from it.

Further, the user interface minimises the number and complexity of interactions that are required to achieve a desired plot state (where a state is a unique plot showing one or more data series). The user can change an interactive plot between views with a single click within the data display region. They can then add or remove additional plot series to a plot view, or pivot to a view presenting a different combination of variables, each with just one further click within the data display region.

The third variable may be quantitative, and values of this variable may be, in at least one state of the user interface, presented as numbers arranged in rows and columns so that the values of the first and second variables of each data point correspond to the first and second sets of user selectable user interface elements.

The user interface may be arranged such that, in response to a user selection of a second one of the first set of user selectable user interface elements, a third graphical representation of the values of the third variable, for data points having the value of the first variable represented by the selected second one of the first set of user selectable user interface elements, is displayed in the data display region, plotted against the values of the second variable represented by the second set of user selectable interface elements, the third graphical representation being positioned adjacent the first graphical representation; and the user interface may be arranged such that, in response to a user selection of a second one of the second set of user selectable user interface elements, a fourth graphical representation of the values of the third variable, for data points having the value of the second variable represented by the selected second one of the second set of user selectable user interface elements, is displayed in the data display region, plotted against the values of the first variable represented by the first set of user selectable interface elements, the fourth graphical representation being positioned adjacent the second graphical representation.

Preferably, the third graphical representation has an appearance that is different than an appearance of the first graphical representation, and the fourth graphical representation has an appearance that is different than an appearance of the second graphical representation.

Preferably, the third graphical representation is a different colour than the first graphical representation, and the fourth graphical representation is a different colour than the second graphical representation.

The user interface may be arranged to present one or more difference elements representing the difference between values represented by the first and third graphical representations, and to present one or more difference elements representing the different between values represented by the second and fourth graphical representations.

Preferably a user interface element of the first or second set of selectable user interface elements represents a number of component data series, and the user interface is arranged such that, in response to a secondary user selection of the user interface element of the first set, the component data series are each displayed in the data display region.

The secondary user selection may comprise a selection of an additional element indicating that the user interface element represents a number of component data series.

The user interface may be arranged such that, in response to a user selection of a user selectable user interface element, the user interface transitions between displaying a first view in the data display region and displaying a second view in the data display region, wherein the transition takes place over a period of time.

Preferably, the user interface is configured for implementation by a touch screen display of computing device.

According to a second aspect of the invention, there is provided computer implemented method for manipulating a data set comprising at least two data points, wherein each data point has at least three variables, the method comprising: in a user interface having a data display region; displaying a first set of user selectable user interface elements arranged in a row, wherein the first set of user selectable user interface elements represents values of a first variable of the data set; displaying a second set of user selectable user interface elements arranged in a column, wherein the second set of user selectable user interface elements represents values of a second variable of the data set, in response to a user selection of a first one of the first set of user selectable user interface elements, displaying, in the data display region, a first graphical representation of the values of a third variable, for data points having the value of the first variable represented by the selected user interface element plotted against the values of the second variable represented by the second set of user selectable interface elements, in response to a user selection of a first one of the second set of user selectable user interface elements, displaying, in the data display region, a second graphical representation of the values of the third variable, for data points having the value of the second variable represented by the selected user interface element plotted against the values of the first variable represented by the first set of user selectable interface elements.

The third variable may be quantitative, and values of this variable may be, in at least one state of the user interface, presented as numbers arranged in rows and columns so that the values of the first and second variables of each data point correspond to the first and second sets of user selectable user interface elements.

The method may further comprise: in response to a user selection of a second one of the first set of user selectable user interface elements, displaying, in the data display region, a third graphical representation of the values of the third variable, for data points having the value of the first variable represented by the selected second one of the first set of user selectable user interface elements plotted against the values of the second variable represented by the second set of user selectable interface elements, the third graphical representation being positioned adjacent the first graphical representation; and in response to a user selection of a second one of the second set of user selectable user interface elements, displaying, in the data display region, a fourth graphical representation of the values of the third variable, for data points having the value of the second variable represented by the selected second one of the second set of user selectable user interface elements plotted against the values of the first variable represented by the first set of user selectable interface elements, the fourth graphical representation being positioned adjacent the second graphical representation.

Preferably, the third graphical representation has an appearance that is different than an appearance of the first graphical representation, and the fourth graphical representation has an appearance that is different than an appearance of the second graphical representation.

Preferably, the third graphical representation is a different colour than the first graphical representation, and the fourth graphical representation is a different colour than the second graphical representation.

The method may further comprise presenting one or more difference elements representing the difference between values represented by the first and third graphical representations, and presenting one or more difference elements representing the different between values represented by the second and fourth graphical representations.

Preferably a user interface element of the first or second set of selectable user interface elements represents a number of component data series, and the method comprises, in response to a secondary user selection of the user interface element of the first set, displaying, in the data display region, each of the component data series.

The secondary user selection may comprise a selection of an additional element indicating that the user interface element represents a number of component data series.

The method may further comprise, in response to a user selection of a user selectable user interface element, transitioning between displaying a first view in the data display area and displaying a second view in the data display region, wherein the transition takes place over a period of time.

According to a third aspect of the invention there is provided a computer program which, when executed by processing means, performs the method of the second aspect.

### BRIEF DESCRIPTION OF THE DRAWINGS

Embodiments of the invention will now be described, strictly by way of example only, with reference to the accompanying drawings, of which:

FIG. 1 is a schematic representation of a user interface display showing an arrangement of header user interface elements;

FIG. 2 is a schematic representation of a user interface display showing the user interface with headers and a table of values;

FIG. 3 is a schematic representation of a user interface display showing the user interface with the column one header selected and its corresponding column plot series;

FIG. 4 is a schematic representation of a user interface display showing the user interface with the column one and column three headers selected and their corresponding column plot series;

FIG. 5 is a schematic representation of a user interface display showing the user interface with row two selected and a bar chart for the corresponding row plot series;

FIG. 6 is a schematic representation of a user interface display showing the user interface with columns 1 and 3 selected, and additional bars added to indicate the differences;

FIG. 7 is a schematic representation of a user interface display showing the user interface with column 1 selected and additional user interface elements adjacent to each row header to allow drilling down;

FIG. 8 is a schematic representation of a user interface display showing the user interface with column 1 selected and row 1 expanded;

FIG. 9 is a schematic representation of a user interface display showing the user interface with row 2 selected and a line chart for the corresponding data series;

FIG. 10 is schematic representation of a user interface with column 1 selected and row 1 expanded, and a waterfall bar chart for the corresponding data series; and

FIG. 11 is schematic representation of a user interface showing profit and loss statement data, with June 2017 selected and a waterfall bar chart for the corresponding data series.

### DESCRIPTION OF THE EMBODIMENTS

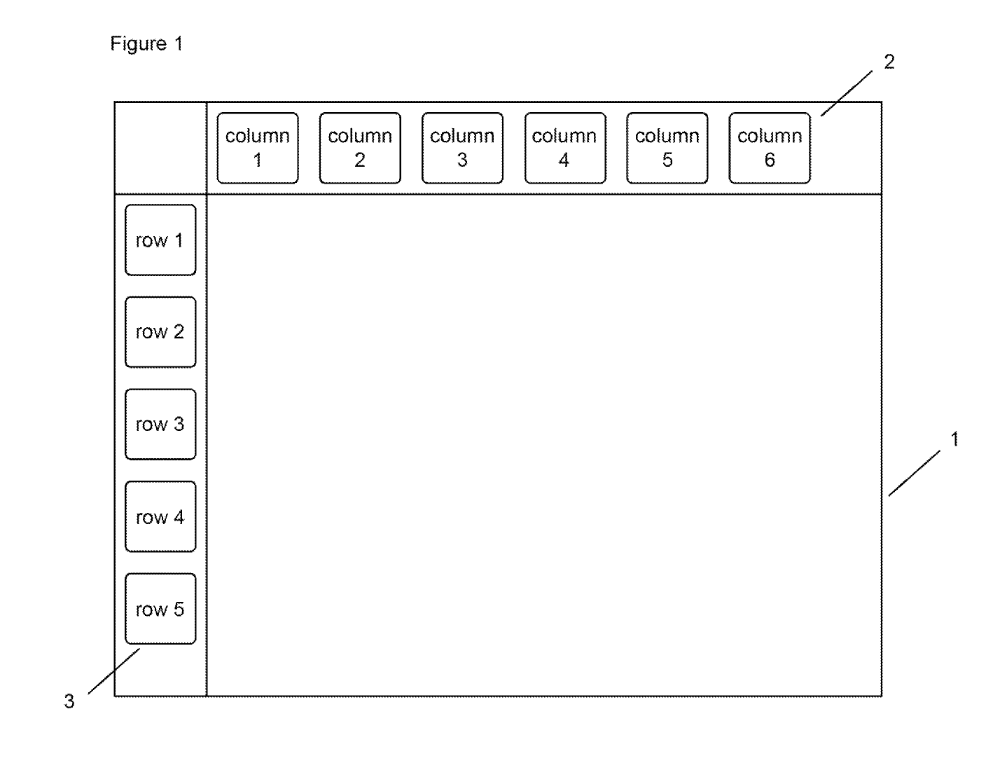

FIG. 1 is a schematic representation of a user interface for manipulating a data set. The user interface includes a data display region 1 and a first set of user selectable user interface elements arranged in a row, which in the schematic illustration of FIG. 1 take the form of six column headers 2. The column headers 2 represent values of a first variable in a data set, such as time periods, and are arranged horizontally towards the top of the data display region 1.

The user interface further includes a second set of user interface elements, which in the schematic illustration of FIG. 1 take the form of five row headers 3. The row headers 3 represent values of a second variable in the data set, such as a category or type of data, and are arranged towards the left edge of the data display region 1.

As will be described in more detail below, the user can select a column header 2 (using, for example, a click of a mouse button when a pointer is positioned over the column header 2, a tap, touch, voice command or other selection action) to display a plot of the values of the third variable against the values of the second variable represented by the row headers 3, for data points having the value of the first variable corresponding to that selected column header, hereinafter referred to as a column plot series. Similarly, the user can select (using, for example, a click of a mouse button when a pointer is positioned over the row header 3, a tap, touch, voice command or other selection action) a row header 3 to select it and display a plot of the values of the third variable against the values of the second variable represented by the column headers 2, for data points having the value of the first variable corresponding to that row header 3, hereinafter referred to as a row plot series.

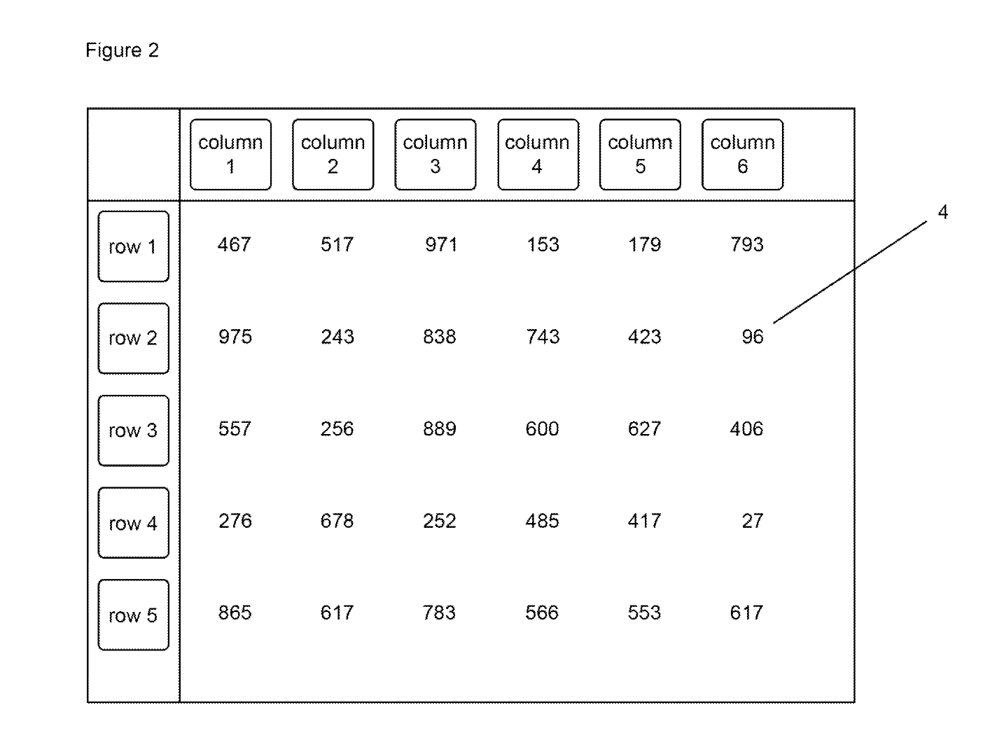

The third variable may be quantitative, and values of this variable are, when none of the column or row headers 2, 3 is selected, presented as a table of numbers indicating the magnitude of the third variable, these numbers being arranged in rows and columns so that the values of the first and second variables of each data point correspond to the column and row headers, as shown in FIG. 2 and described in more detail below.

Preferably, when one or more column headers 2 is already in a selected state and the user selects a row header 3, the column headers 2 are programmatically de-selected and the corresponding column plot series are removed from the display. Similarly, when one or more row headers 3 is already in a selected state and the user selects a column header 2, the row headers 3 are programmatically de-selected and the corresponding row plot series are removed from the display. The result of these behaviours is that the display cannot be in a state where both row and column headers 3, 2 are selected at the same time.

Preferably each selected column or row header 2, 3 is displayed with a distinctive appearance characteristic so that its selected state is discernible to the user. Furthermore, graphical components of the corresponding column or row plot series are preferably shown with the same appearance characteristics as the selected header, so that the user is made aware of their relationship with the selected header.

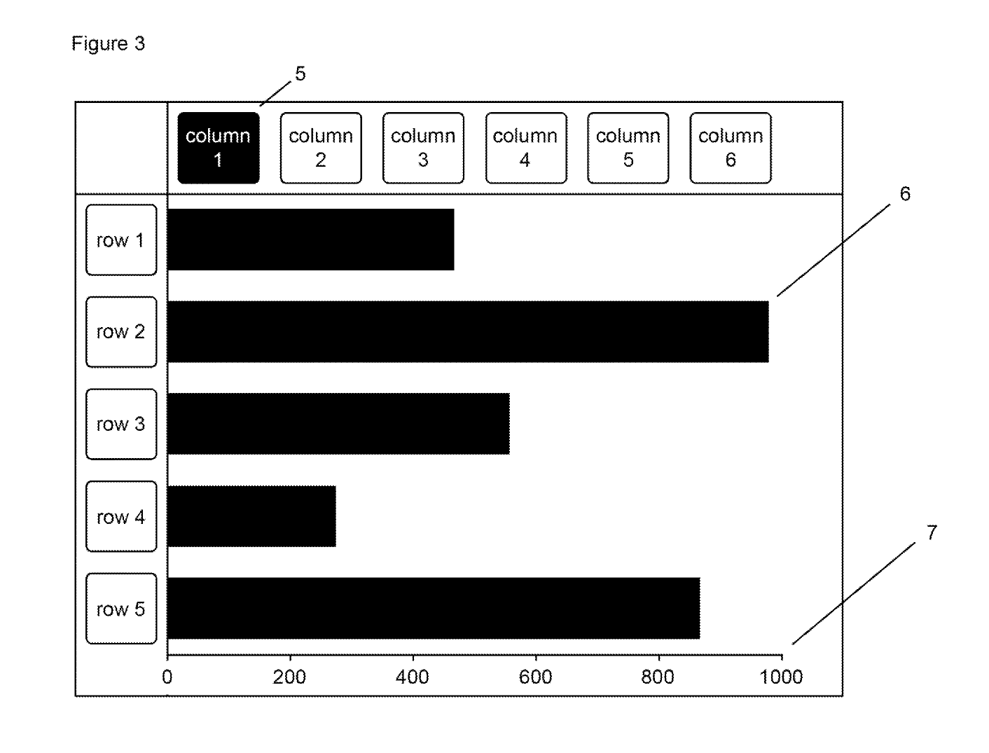

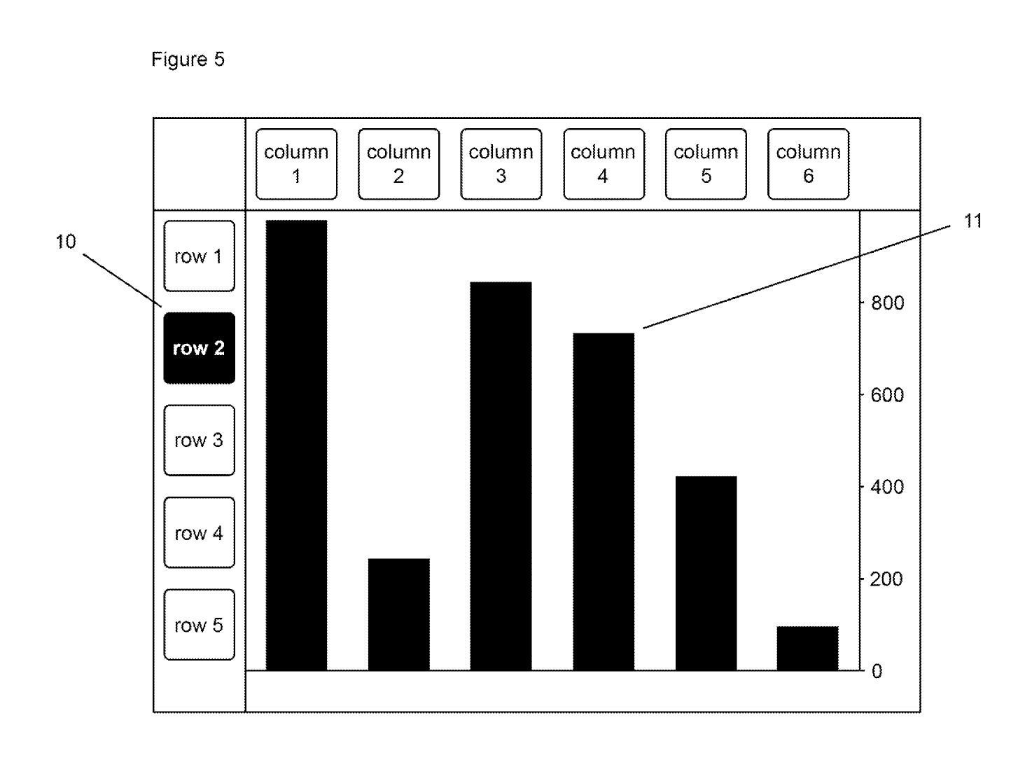

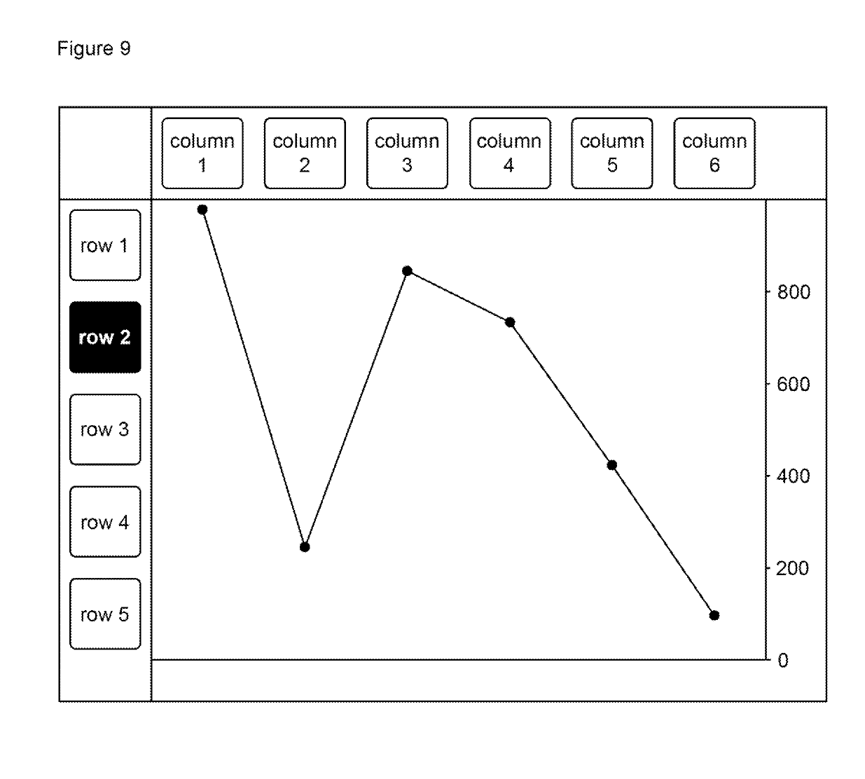

As will be described in more detail below, the user interface has at least three types of display, hereinafter referred to as views:
1. table view: all column and row headers are unselected, and the numerical values of the third variable are displayed as a table (e.g. as shown in FIG. 2);
2. column view: all row headers are unselected, one or more column headers are selected, and the corresponding column plot series are displayed (e.g. as shown in FIGS. 3, 4, 6, and 7);
3. row view: all column headers are unselected, one or more row headers are selected, and the corresponding row plot series are displayed (e.g. as shown in FIGS. 5 and 9).

When the user changes between two of these three views it can be considered that the display is pivoting.

The row and column headers 3, 2 preferably remain in substantially the same position in all three views.

The row and column headers 3, 2 are used as the primary user interface elements, so there is no need for additional user interface elements positioned away from, and visually disassociated from, the data display region 1. In particular, no separate user interface elements are required to change between the three views or to add or remove a plot series from a view, and separate legends are not required to identify plot series.

This is achieved by the column and row headers 2, 3 having multiple purposes:
1. they act as identifiers for rows and columns;
2. they function as filters for the user to select to cause a row or column plot series to be displayed, or removed from the display;
3. they act as legends, to identify a plot series.

The user can generate many different plot states with one or two clicks (or other selection actions) on the column and row headers 2, 3 that are part of the main data display region 1. For a data display region showing a table view with N column headers and M row headers, the user can with one click change the display to show any of N+M desired states. With a sequence of up to two clicks the number of possible states is (N+_{N}C₂)+(M+_{M}C₂), where _{N}C₂ represents the number of combinations of two elements that can be picked from a set of N elements. So, if there are twelve column headers and ten row headers the number of possible new states after one or two clicks is (12+66)+(10+45)=133. This ability to easily generate a desired set of plots lets the user quickly compare values in any set of columns or rows, in order to identify significant differences, trends and other patterns.

The consistent presence and positions of the column and row headers 2, 3 is similar to the arrangement in a typical spreadsheet that has row headers in an upper row of a worksheet and column headers in a left column. However, unlike in spreadsheet and other existing software, the table and plot views, and the user controls that configure them, are fully integrated into a single interactive data display region.

A further effect and advantage of the current invention is that user interactions with the interface, such as the ability to drill down and up that is described hereafter, can operate in a similar way in all three main views: table, column and row. So, for example, having drilled down and expanded a row of data in a column view, the user might then change to a row view by clicking on the header of a row that is of interest, and the expanded condition of the row is maintained.

In the schematic representation of FIG. 1, each of the six column headers 2 and each of the five row headers 3 is depicted as a rounded rectangle around a text label identifying the column or row. These rounded rectangles each represent a button that the user can select to select the row or column header. In a real user interface, it is not necessary for the button to be visible; it can just be an area around the label of the row or column header label that responds to a click of a mouse button when a pointer is over the area, a tap, a touch, a voice command or any other selection action. Further, the text label need not be part of the column or row header 2, 3 or the user-selectable button; the text labels may be positioned outside of the user-selectable button area or column or row header 2, 3.

FIG. 2 is a schematic representation of the user interface of FIG. 1 showing a table view, with numerical values 4, representing values of a third variable in the data set, such as amounts of money, arranged in columns and rows corresponding to the column and row headers 2, 3.

FIG. 3 shows the appearance of the data display region 1 when the column header 5 labelled “column 1” has been selected, e.g. by clicking, tapping, touching, giving a voice command or performing some other selection action on the column header 5. This selection of the column header 5 changes it to a selected state, which is indicated by a change of the appearance of the column header 5. In the example illustrated in FIG. 3, the colour of the column header 5 button has changed to black and its text label has changed to white, to maintain its visibility. The number values that were displayed in the table view of FIG. 2 have been removed and a horizontal bar chart 6 is now shown, as one example of a column plot series. Thus, the values 467, 995, 557, 276 and 865 which appear in the leftmost column of the table view in FIG. 2 are now represented by bars. The bars of the bar chart are black, as is the “column 1” column header 5, to indicate to the user that they represent the values of column 1. The bars are vertically aligned with the row headers to indicate that the quantitative values they represent correspond to the values of the row headers. As in a normal bar chart the length and area of each bar is proportional to the value that it represents so that the user can judge the magnitude of those values. The introduction of a horizontal axis and scale 7 can help the user judge the absolute magnitude of the values in this view.

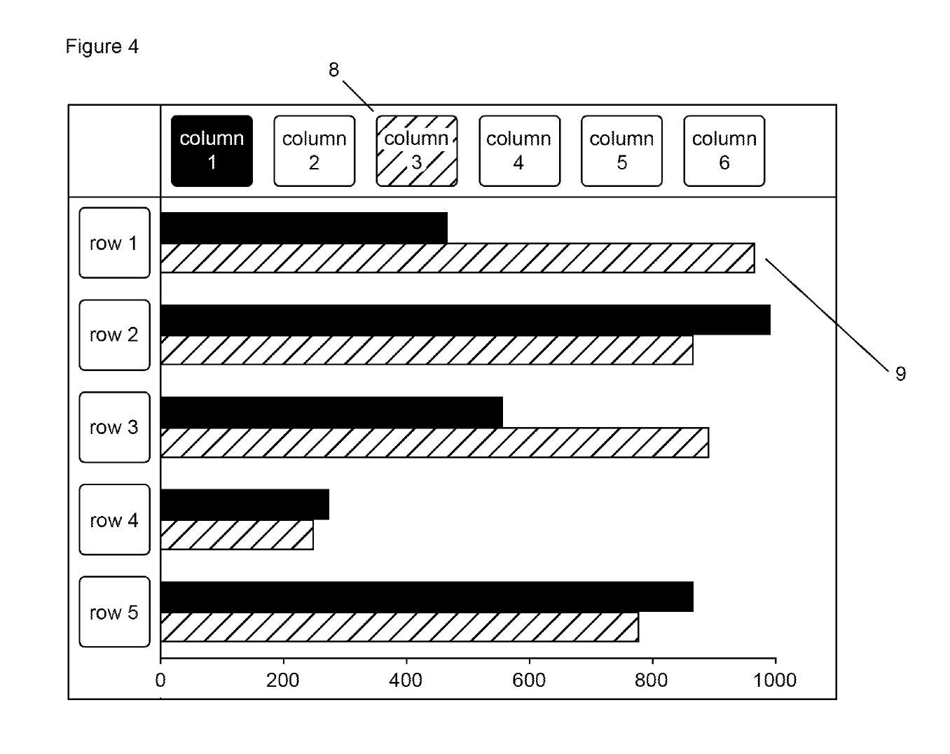

FIG. 4 shows the user interface after the user has, when the interface was as shown in FIG. 3, selected a second column header (in this example the column header 8 labelled “column 3”). The “column 3” column header 8 has a hatching pattern to indicate that it is selected, and bars for the “column 3” column plot series 9 are now presented in the data display region 1, adjacent the bars for the “column 1” column plot series, to facilitate comparison between the “column 1” series and the “column 3” series. The bars for the “column 3” column plot series 9 have that same hatching pattern as the selected “column 3” column header 8. The bars in the column plot series for columns 1 and 3 may also be reduced in height so that they remain vertically aligned with their corresponding row headers.

Whilst in the schematic representation of FIG. 4 the “column 3” objects are identified by a hatch pattern, it is preferable to do so by a colour. So, the “column 3” header and column plot series bars could, for example, be coloured blue.

With the user interface as shown in FIG. 4, the user can select a third column header, such as that labelled “column 5”, and its column plot series would be displayed, in addition to those of columns 1 and 3, adjacent the column plot series for the other selected column headers. Alternatively, the number of plot series that can be shown simultaneously can be limited to a fixed number, for example two, in order to keep the plot relatively simple and easy to interpret.

FIG. 5 shows the user interface after the user has, with the interface as shown in FIG. 2, 3 or 4, selected the row header 10 labelled “row 2”, to cause a row view to be displayed. The row view is a vertical bar chart 11 in which the values of the third variable, for data points having a value ‘row 2’ of the second variable, are shown as bars for each of the values of the first variable. Thus, the values 975, 243, 838, 743, 423 and 96 which appear in the second from top row of the table view in FIG. 2 are now represented by bars. Any column headers that had been selected are now deselected, and any column plot series that were shown have been removed.

As is the case for the column headers, when more than one row header is selected by the user, the corresponding row plot series are displayed adjacent one another, to facilitate comparison between the selected row plot series.

The display in FIG. 4 illustrates how the user can readily compare values, in this case between the values in column 1 and those in column 3. In data visualisation, the significance of a value is frequently only apparent when it is compared to another relevant value.

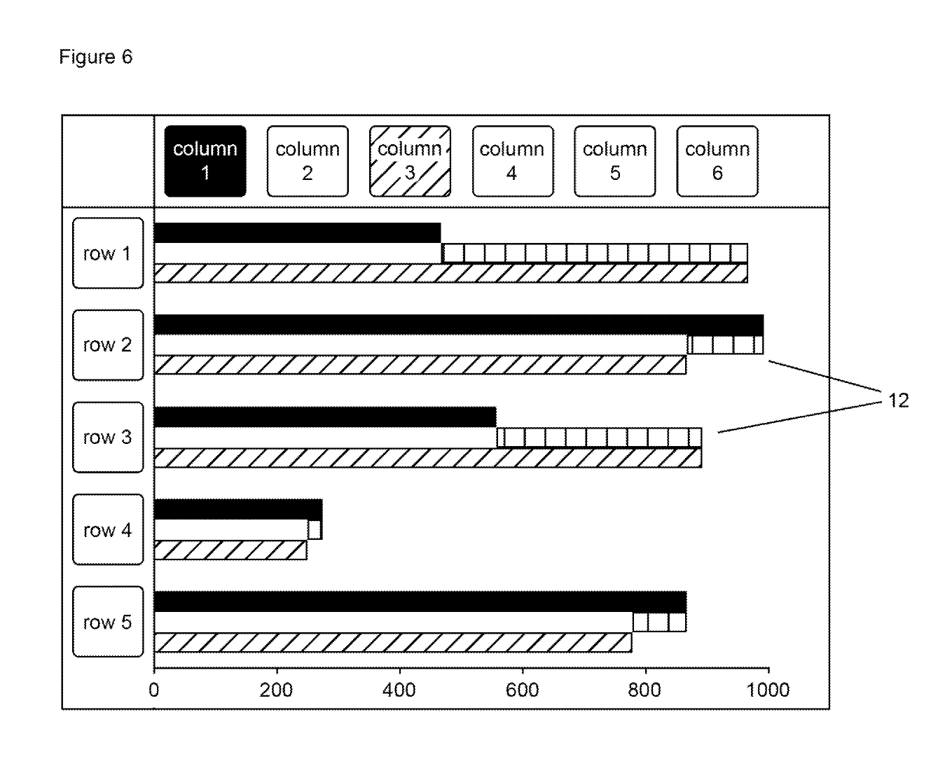

For some applications, it can be advantageous for the display to include additional graphical elements to represent the differences or changes between corresponding values, as shown in FIG. 6. The additional difference elements 12 can be positioned between the ends of the bars for column 1 and 3, so the width of each additional element is proportional to the difference between their values.

The difference elements 12 are shown in FIG. 6 with a vertical hatch pattern, but in a real-world implementation of the user interface they would be shown in a colour that indicated their significance. For example, if row 1 were a category that had a positive meaning (such as a sales account in a profit and loss report) then an increase in value from column 1 to column 3 would be a positive change that would be shown in green, while a decrease in value would be shown in red. Similarly, for a category with a negative meaning (such as overhead costs in a profit and loss report), an increase would be shown in red and a decrease in green.

The differences that can be shown in this way can be between selected columns (in a column view), or between selected rows (in a row view).

Another area of functionality of the user interface system is the ability to drill down into data by expanding one or more columns or rows to see its components. This can help the user explore and understand the data set.

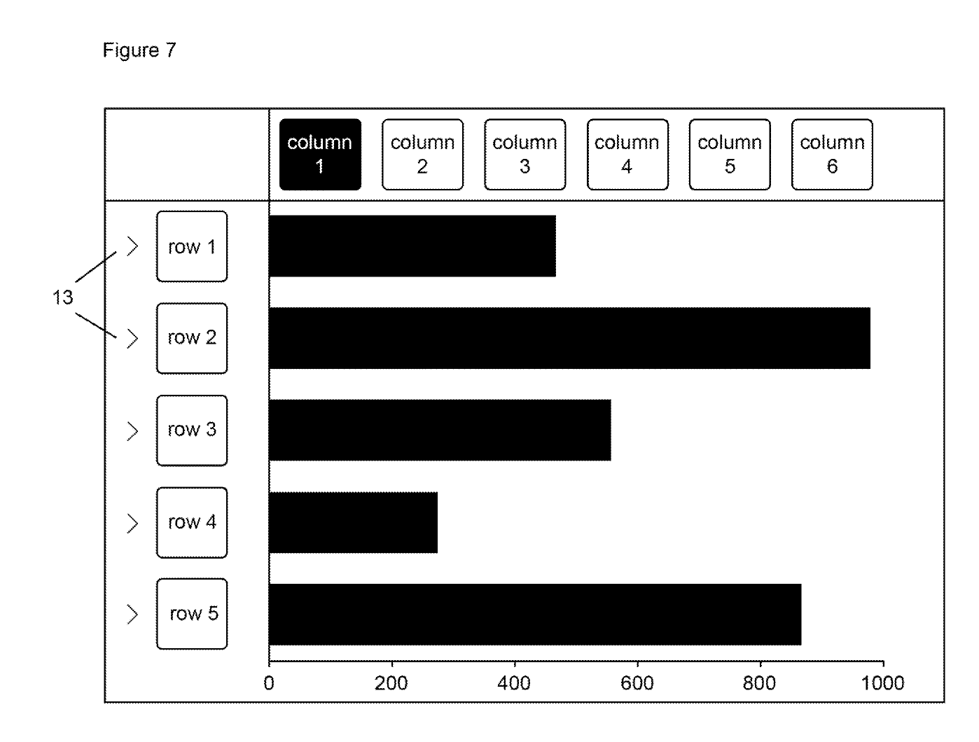

This can be enabled by means of additional user interface elements positioned adjacent to headers whose data can be expanded, or by a secondary user interaction (such as a double-click) on the header itself. For example, the row headers may each be made up from a number of component data series and this can be indicated, as shown in FIG. 7, by the presence of right facing chevrons 13 next to the row headers. When the user selects (e.g. clicks on, taps, touches, gives a voice command) a chevron, its row is expanded and the component data series are each then shown as a separate row.

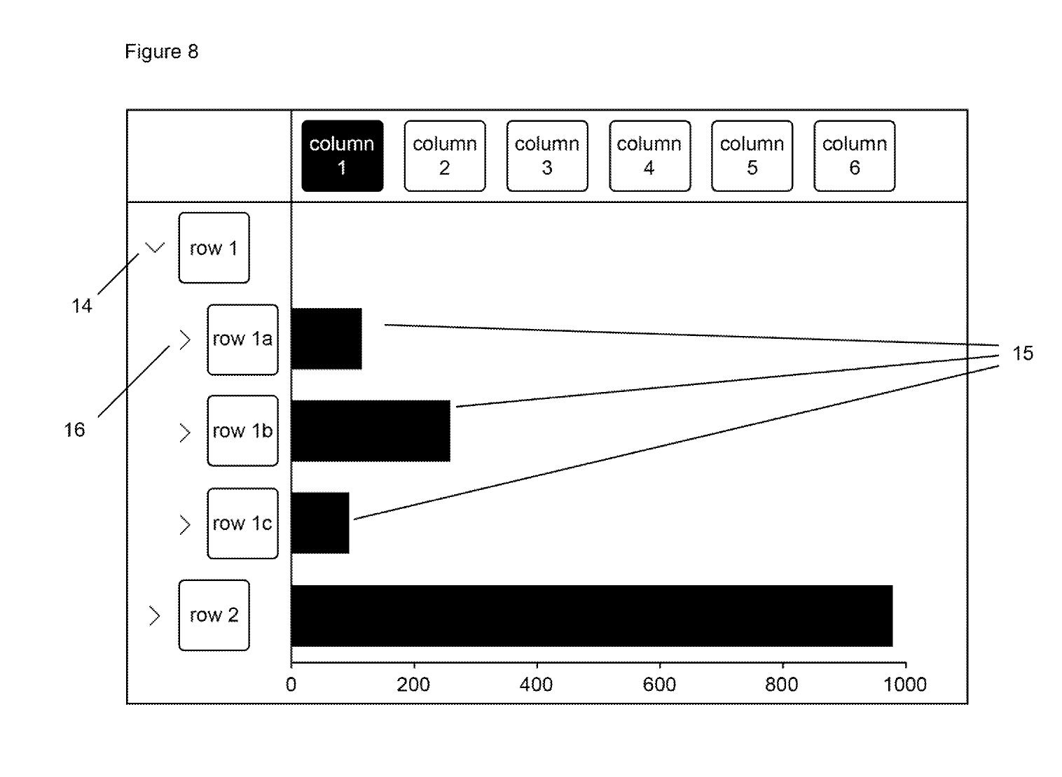

FIG. 8 shows the display after the chevron 14 next to the row 1 header in FIG. 7 has been clicked, at which point that chevron's orientation changes so that it points downwards. The column 1 values for the components of row 1 (row 1a, row 1b and row 1c) are each shown as bars 15.

It will be noted that the bars for rows 2 to 5 have moved downwards, and those for rows 3 to 5 have moved out of the data display region and are no longer visible. The interface therefore includes a scrolling capability to allow the user to move the display up and down to view different parts. This might be by a click-and-drag action with the mouse, a press and drag on a touchscreen, or by use of a scroll bar.

With the interface in the state shown in FIG. 8, the user could drill down further, for example by further expanding row 1a to see its components, by clicking on the chevron 16 next to its row header. Or the user could collapse the components of row 1 by clicking again on the down chevron 14 by the side of the row 1 header, to return the display to its arrangement in FIG. 7.

It will be apparent that, where the variable represented by the column headers is also structured, this kind of drill down and up functionality can be implemented for the column headers in a similar way to that described above for the row headers.

It should be noted that the drill down and up functionality operates in a similar way in all three main views: table, column and row. Furthermore, the state of expansion of the data can be maintained between views. So, for example, having drilled down and expanded a row of data in a column view, the user might then change to a row view by clicking on the header of a row that is of interest, and the expanded condition of one or more rows is maintained. Furthermore, the comparison capabilities described above can work equally well on drilled down views.

In FIG. 5 the row view is a vertical bar chart, but alternative plot types may be advantageous for one or more of the main views.

For example, if the first variable is time, so that column headers represent time periods or points in time, then the row plot series is preferably a line chart, as shown in FIG. 9.

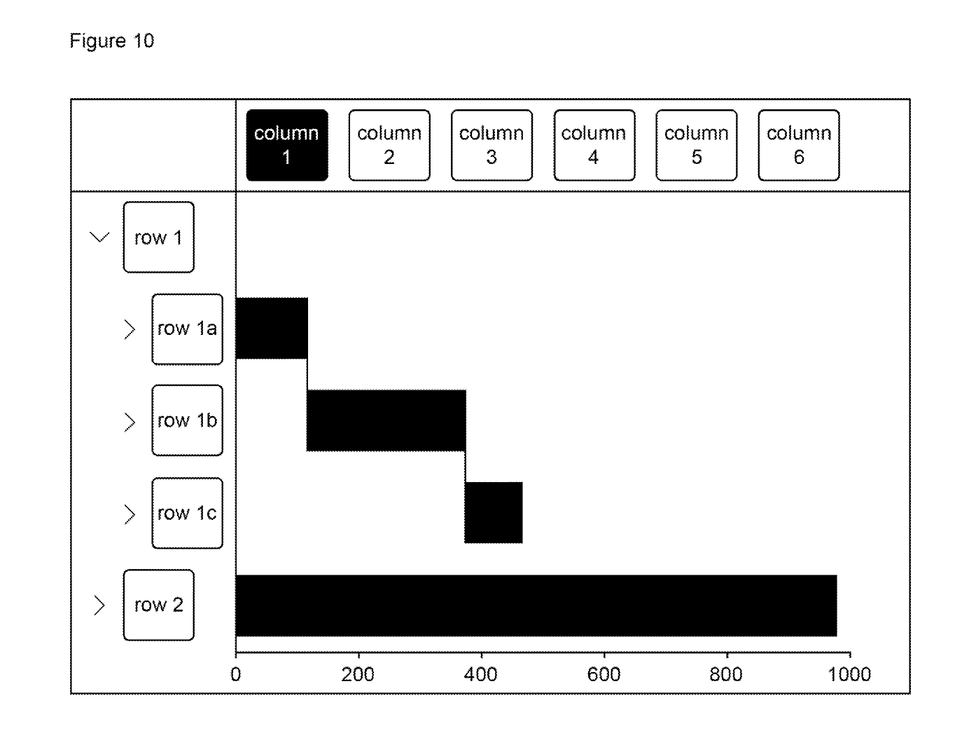

Waterfall bar charts can be used to show the arithmetic relationship between values. If a row has components whose values add up to the row value, then when the row is expanded while viewing the horizontal bar chart of a column view, it is preferable to show the components in a waterfall bar chart. This is illustrated in FIG. 10.

Other types of plot that can be used in the current invention will be apparent to one skilled in the art.

When the user selects a user interface element, the display changes from a previous state to a new target state. When this happens some objects in the display may disappear, as they are not required in the target state. Other objects appear as they were not present in the previous state, but are required in the target state. Some objects that are present in both the previous and target states may change form (e.g. from text to a bar), or vary in their position, size, shape or appearance. In all of these cases it is preferable that the transitions take place continuously over a time period, rather than immediately. This can help the user better understand the meaning of the transitions.

For example, when the user selects the “column 1” header 5 in the table view shown in FIG. 2, causing the display to change to the column view shown in FIG. 3, a series of continuous transitions may be performed by the user interface:
the “column 1” header 5 gradually changes from its de-selected appearance (black text on a white background) to its selected appearance (white text on a black background);
all the numerical values of the table gradually disappear;
the bars gradually appear, initially at a small size, at the positions of the numerical values in column 1 of the table view, and then they grow in width and height and their positions change until they reach the arrangement shown in FIG. 3; this gives the appearance that the column 1 numbers are transforming into the bars, informing the user that they represent the same data entities;
the horizontal axis and scale gradually appears.

Specifically, in the above example, the top bar in FIG. 3 initially appears as a small rectangle at the position and with the same size as the number 467 at the column 1/row 1 position in FIG. 2, before growing taller and wider until its width value is equal to 467 on the scale shown on the horizontal axis of FIG. 3.

When similar meaningful transitions are implemented for all changes between different states, the user is better informed of how objects in consecutive states of the interface are related to each other, facilitating interpretation of the plots. This is particularly significant for the current invention as the interface can display at least three different views in the same data display region. If the different views and states were to jump instantaneously from one to the next then that discontinuity would make the plots harder to interpret.

An example of a class of data that can advantageously be presented and explore using the invention is a company's financial reports and statements, such as Profit and Loss, Balance Sheet and Cashflow.

When a time series of Profit and Loss Statements is presented, the first variable, represented by the column headers, is typically a series of consecutive time periods, such as years or months, and the second variable, represented by the row headers, is nominal ledger profit and loss accounts, and aggregations of them.

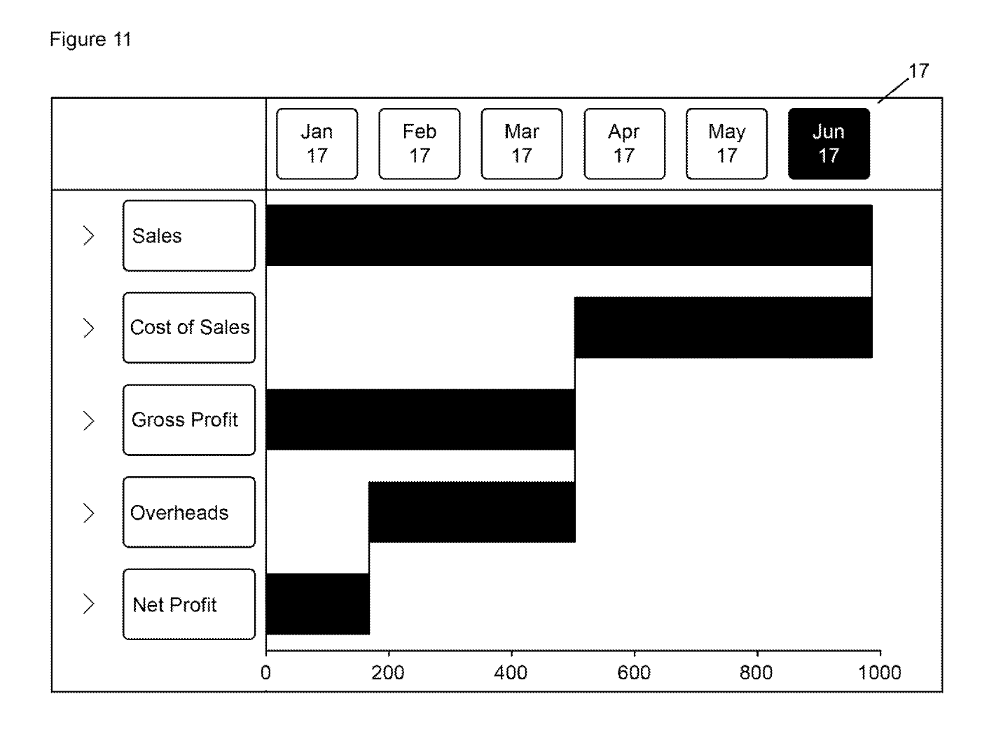

This is illustrated in FIG. 11, which shows the interface for a simplified set of profit and loss statements. Column header 17 for June 17 (June 2017) has been selected, to display the column plot for the figures for that month. In this example, a waterfall bar chart is used to show the arithmetic relationships between the account totals. The gross profit is equal to the sales figure less the cost of sales, and the net profit is the gross profit less the overheads.

The user can readily examine various aspects of the statement by means of user interactions previously described, in order to assess the financial performance of the organisation. For example, the user can:
compare the June 2017 results with those of the previous month, May 2017, by next clicking on the May 17 header;
see the how the component accounts of the Sales add up to that total, by clicking on the chevron to the left of the Sales row header;
explore how the Sales total has varied over the six month period shown, by clicking on the Sales row header.

When presenting accounts statements, the actual historic figures are typically compared to the corresponding budgeted figures, and the differences are treated as variances from the budget. The nature or type of the figures (e.g. actual, budget, projection, benchmark) can be treated as a fourth variable of the data set. Additional user interface elements can be provided to allow the user to direct the interface to display an additional type, such as the budget, to be compared with the actual values, with variances shown as numbers in the table view and represented as difference graphical elements in the column and row views.

Use of the interface to present accounting reports is especially advantageous when accounts data is programmatically transferred to the software system from a company's accounting software, such as a cloud-based system like Xero.

Several other modes of user interaction can be added to the user interface to complement those previously described

At certain points during the exploration or presentation of a data set the user may, while the interface is displaying a column or row view, wish to view the numerical values corresponding to the graphical elements in the plot. This is conveniently achieved by the user action of selecting (e.g. clicking on, tapping touching, or giving a voice command) an element of the plot to cause its numerical value to be displayed adjacent to the element. Selecting (e.g. clicking on, tapping, touching, or giving a voice command) the element again causes the numerical value to be removed.

As has previously been mentioned, the number of columns or rows of data to be displayed in a given view may be larger than can be conveniently shown within the data display region. In this case a scrolling capability is available to the user, for example by clicking and dragging over the data display region. When the plots are scrolled the header elements should also move, so they remain aligned with the data to which they correspond.

It may also be desirable to zoom the plot display for one or more of the variables. For example, in the example of profit and loss statements, while viewing a line chart of Sales in a row view, the user may wish to see the variations of Sales over a longer period. The interface can be programmed to have an interaction to allow this; when the user input mechanism is a touchscreen this action is typically an inwards pinch action. After such an action the plot might show, for example variations of Sales over a three year period, rather than just the six months initially shown.

It will be appreciated that the user interface described herein provides a compact, integrated, intuitive user interface that is straightforward to learn and use and requires minimal user interactions to configure a plot. Complex data sets having three or more variables can be plotted and visualised quickly and easily. Further, by integrating the user interface elements used to manipulate the data set within the data display region, the screen area available for displaying plots representing the data is maximised, and the attention of the user is focused on the display area. This makes the user interface particularly suited to small form factor devices with touch screen interfaces such as mobile phones and tablet computers.

As will be appreciated, the user interface is implemented in software that can be executed by any suitable computing platform, for example a desktop or portable personal computer, a notepad or tablet computer or a mobile device such as a smartphone or other mobile telephone.

The software can take advantage of a range of display devices including monitors, integrated screens, projectors and virtual reality, augmented reality and mixed reality displays, which can be head mounted.

The software can accept input from a variety of user input devices including mouse, keyboard, touchpad, touchscreen, hand or body tracked gestures and voice recognition.

The invention is particularly effective when used on mobile devices with touchscreens, such as smartphones and tablets, as the act of tapping on a header causes a plot of the related data to be displayed. This kind of direct interaction has been shown to be more intuitive and engaging than indirect interaction via a pointing device such as a mouse. Furthermore, the lack of separate user interface elements means that the data display region can fill a high proportion of the display, so the data display region can be as large as possible on the small screens of mobile devices.

Software implementing the user interface can be developed to be a locally stored program on a desktop or portable computer, or on a mobile device (i.e. a native app). Alternatively, it can be a web or hybrid application whose user interface is downloaded from a web server and then runs locally in a web browser. In this latter case, a substantial part of the functionality of the system may be provided by software running on the server.

The software can be coded as a stand-alone system, or as an extension or plug-in for an existing software system, such as Microsoft Excel, Microsoft Power BI, Tableau or Qlik, or it can be implemented as a fully integrated part of such software.

The data that is visualised can be stored locally on the computing device, stored on a remote computing device such as a web server, or may be accessed from an external system on demand.

Many types of data have three or more dimensions or variables, and are therefore suitable for display in the user interface. The invention is particularly effective when the first variable referred to above is time, the second variable is a category or type of data that is structured, preferably hierarchically, and the third variable is quantitative. Some examples of such data sets include:
a company's financial accounts, such as profit and loss statements (first variable: time; second: account name; third: amount of money);
marketing information with metrics such as visitor numbers, page visits and action counts for websites and social media (time; name of metric; count value of metric);
personal healthcare data such as heart rate, breathing rate, blood pressure, cholesterol level, blood glucose level, activity (time; name of measure; value of measure);
data from scientific and engineering instrumentation, such as sensors in a car measuring speed, acceleration, G-forces, vibration levels, steering, braking (time; name of measure; value of measure).

1. A user interface for manipulating a data set comprising at least two data points, wherein each data point has at least three variables, the user interface comprising:
a data display region;
a first set of user selectable user interface elements arranged in a row, wherein the first set of user selectable user interface elements represents values of a first variable of the data set;
a second set of user selectable user interface elements arranged in a column, wherein the second set of user selectable user interface elements represents values of a second variable of the data set,
wherein the user interface is arranged such that, in response to a user selection of a first one of the first set of user selectable user interface elements, a first graphical representation of the values of a third variable, for data points having the value of the first variable represented by the selected user interface element, is displayed in the data display region, plotted against the values of the second variable represented by the second set of user selectable interface elements,
and wherein the user interface is arranged such that, in response to a user selection of a first one of the second set of user selectable user interface elements, a second graphical representation of the values of the third variable, for data points having the value of the second variable represented by the selected user interface element, is displayed in the data display region, plotted against the values of the first variable represented by the first set of user selectable interface elements.

2. The user interface according to claim 1, wherein the third variable is quantitative, and wherein values of the third variable are, in at least one state of the user interface, presented as numbers arranged in rows and columns so that the values of the first and second variables of each data point correspond to the first and second sets of user selectable user interface elements.

3. The user interface according to claim 2, wherein:
the user interface is arranged such that, in response to a user selection of a second one of the first set of user selectable user interface elements, a third graphical representation of the values of the third variable, for data points having the value of the first variable represented by the selected second one of the first set of user selectable user interface elements, is displayed in the data display region, plotted against the values of the second variable represented by the second set of user selectable interface elements, the third graphical representation being positioned adjacent the first graphical representation; and
wherein the user interface is arranged such that, in response to a user selection of a second one of the second set of user selectable user interface elements, a fourth graphical representation of the values of the third variable, for data points having the value of the second variable represented by the selected second one of the second set of user selectable user interface elements, is displayed in the data display region, plotted against the values of the first variable represented by the first set of user selectable interface elements, the fourth graphical representation being positioned adjacent the second graphical representation.

4. The user interface according to claim 3, wherein the third graphical representation has an appearance that is different than an appearance of the first graphical representation, and wherein the fourth graphical representation has an appearance that is different than an appearance of the second graphical representation.

5. The user interface according to claim 4, wherein the third graphical representation is a different colour than the first graphical representation, and wherein the fourth graphical representation is a different colour than the second graphical representation.

6. The user interface according to claim 3, wherein the user interface is arranged to present one or more difference elements representing the difference between values represented by the first and third graphical representations, and to present one or more difference elements representing the different between values represented by the second and fourth graphical representations.

7. The user interface according to claim 1, wherein a user interface element of the first or second set of selectable user interface elements represents a number of component data series, and wherein the user interface is arranged such that, in response to a secondary user selection of the user interface element of the first set, the component data series are each displayed in the data display region.

8. The user interface according to claim 7, wherein the secondary user selection comprises a selection of an additional element indicating that the user interface element represents a number of component data series.

9. The user interface according to claim 1, wherein the user interface is arranged such that, in response to a user selection of a user selectable user interface element, the user interface transitions between displaying a first view in the data display region and displaying a second view in the data display region, wherein the transition takes place over a period of time.

10. The user interface according to claim 1, wherein the user interface is configured for implementation by a touch screen display of computing device.

11. A computer implemented method for manipulating a data set comprising at least two data points, wherein each data point has at least three variables, the method comprising:
in a user interface having a data display region;
displaying a first set of user selectable user interface elements arranged in a row, wherein the first set of user selectable user interface elements represents values of a first variable of the data set;
displaying a second set of user selectable user interface elements arranged in a column, wherein the second set of user selectable user interface elements represents values of a second variable of the data set,
in response to a user selection of a first one of the first set of user selectable user interface elements, displaying, in the data display region, a first graphical representation of the values of a third variable, for data points having the value of the first variable represented by the selected user interface element, plotted against the values of the second variable represented by the second set of user selectable interface elements,
in response to a user selection of a first one of the second set of user selectable user interface elements, displaying, in the data display region, a second graphical representation of the values of the third variable, for data points having the value of the second variable represented by the selected user interface element, plotted against the values of the first variable represented by the first set of user selectable interface elements.

12. The computer implemented method according to claim 11, wherein the third variable is quantitative, and wherein values of the third variable are, in at least one state of the user interface, presented as numbers arranged in rows and columns so that the values of the first and second variables of each data point correspond to the first and second sets of user selectable user interface elements.

13. The computer implemented method according to claim 12, further comprising:
in response to a user selection of a second one of the first set of user selectable user interface elements, displaying, in the data display region, a third graphical representation of the values of the third variable, for data points having the value of the first variable represented by the selected second one of the first set of user selectable user interface elements plotted against the values of the second variable represented by the second set of user selectable interface elements, the third graphical representation being positioned adjacent the first graphical representation; and
in response to a user selection of a second one of the second set of user selectable user interface elements, displaying, in the data display region, a fourth graphical representation of the values of the third variable, for data points having the value of the second variable represented by the selected second one of the second set of user selectable user interface elements plotted against the values of the first variable represented by the first set of user selectable interface elements, the fourth graphical representation being positioned adjacent the second graphical representation.

14. The computer implemented method according to claim 13, wherein the third graphical representation has an appearance that is different than an appearance of the first graphical representation, and wherein the fourth graphical representation has an appearance that is different than an appearance of the second graphical representation.

15. The computer implemented method according to claim 14, wherein the third graphical representation is a different colour than the first graphical representation, and wherein the fourth graphical representation is a different colour than the second graphical representation.

16. The computer implemented method according to claim 13, further comprising presenting one or more difference elements representing the difference between values represented by the first and third graphical representations, and presenting one or more difference elements representing the different between values represented by the second and fourth graphical representations.

17. The computer implemented method according to claim 10, wherein a user interface element of the first or second set of selectable user interface elements represents a number of component data series, and wherein the method comprises, in response to a secondary user selection of the user interface element of the first set, displaying, in the data display region, each of the component data series.

18. The computer implemented method according to claim 17, wherein the secondary user selection comprises a selection of an additional element indicating that the user interface element represents a number of component data series.

19. The computer implemented method according to claim 10, further comprising, in response to a user selection of a user selectable user interface element, transitioning between displaying a first view in the data display region and displaying a second view in the data display region, wherein the transition takes place over a period of time.

20. A computer program which, when executed by processing means, performs the method claim 11.
